(19) United States
(12) Patent Application Publication
(10) Pub. No.: US 2009/0232150 A1
(43) Pub. Date: Sep. 17, 2009

(54) SERVICE EDGE PLATFORM ARCHITECTURE FOR A MULTI-SERVICE ACCESS NETWORK

(75) Inventor: Nalin Mistry, Nepean (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/573,473

(22) PCT Filed: Aug. 25, 2005
(86) PCT No.: PCT/IB05/02536

§ 371 Date: Feb. 9, 2007

Related U.S. Application Data
(60) Provisional application No. 60/605,299, filed on Aug. 27, 2004.

(51) Int. Cl. H04L 12/56

(52) U.S. Cl. 370/419

(57) ABSTRACT

A service edge node for a multi-service access (MSA) network is provided. The service edge node includes a line card, numerous service cards, a control system, and switching fabric. The line card receives packets from an access network and removes framing information from the packets to provide raw packets. For each of the packets, the raw packet from the line card is directed to one of the service cards. In one embodiment, each of the service cards is dedicated to a particular logical channel, and the line card is configured to direct the packets based on the logical channels. In another embodiment, each of the service cards is dedicated to a particular traffic type, and the line card directs the raw packets to the service cards based on a preconfigured table from the control system defining the traffic type of each of the service cards.

This application claims the benefit of U.S. provisional patent application Ser. No. 60/605,299, filed Aug. 27, 2004, the disclosure of which is hereby incorporated by reference in its entirety.

### FIELD OF THE INVENTION

The present invention relates to multi-service access networks and more particularly to a service edge node for a multi-service access network.

### BACKGROUND OF THE INVENTION

The primary function of a multi-service access (MSA) network is to provide packet transport up to a service edge node. In today's network, the transport function is typically time-division multiplexing (TDM) or circuit-switching in nature (ex. DS0, DS1, OC3). As Metro transport networks evolve to more efficiently carry packet and circuit traffic, two approaches have developed: a circuit efficiency approach based on Generic Framing Protocol (GFP), Virtual Concatenation (VCAT), or Link Capacity Adjustment (LCAS) and a packet efficiency approach using Internet Protocol (IP) or Multiprotocol Label Switching (MPLS) or Ethernet. Of these two approaches, the packet efficiency approach is viewed as being more efficient while enabling new transport services and is deemed to become the normalized technology of the future.

A key component of an MSA network is a service edge node. A typical platform architecture of a service edge node includes line, service, fabric, and control functions. Each of these functions is typically supported on a single physical card. In some cases, two or more of these functions are combined into a single physical card. Further, a typical service edge node platform architecture has a 1:1 relationship between line cards and service cards. However, using a single service card to process packets corresponding to numerous logical channels (ex. Synchronous Transport Signal (STS) or Virtual Local Area Network (VLAN) channels) and/or numerous traffic types (ex. public IP, private IP, Layer 2 Virtual Private Network (VPN), and Layer 3 VPN) limits the efficiency of the service edge node and thus the MSA network.

Accordingly, there remains a need for a more efficient service edge node.

### SUMMARY OF THE INVENTION

The present invention provides a service edge node for a multi-service access (MSA) network. In general, the service edge node includes a line card, numerous service cards, a control system, and switching fabric. The line card receives packets from an access network and removes framing information from the packets to provide raw packets. For each of the packets, the raw packet from the line card is directed to one of the service cards. In one embodiment, each of the service cards is dedicated to a particular logical channel, and the line card is configured to direct the packets based on the logical channels. In another embodiment, each of the service cards is dedicated to a particular traffic type, and the line card directs the raw packets to the service cards based on a pre-configured table from the control system defining the traffic type of each of the service cards. The service cards process the raw packets based on routing information from the control system to provide processed packets and communicate the processed packets to the switching fabric for transmission over a core packet network.

In one embodiment, the service edge node includes a first line card coupled to a first set of service cards and a second line card coupled to a second set of service cards. The first line card receives packets from an access circuit-switching network and removes framing information from the packets to provide raw packets. For each of the packets, the first line card directs the raw packet to one of the first set of service cards. In one embodiment, each of the first set of service cards is dedicated to a particular logical channel, and the line card directs the raw packets based on the logical channels. In another embodiment, each of the first set of service cards is dedicated to a particular traffic type, and the line card directs the raw packets based on traffic type. The second line card receives packets from an access packet network and removes framing information from the packets to provide raw packets. For each of the packets, the second line card directs the raw packet to one of the second set of service cards. In one embodiment, each of the second set of service cards is dedicated to a particular logical channel, and the second line card directs the raw packets based on the logical channels. In another embodiment, each of the second set of service cards is dedicated to a particular traffic type, and the second line card directs the raw packets based on traffic type. The first and second set of service cards process the raw packets based on routing information from the control system to provide processed packets and communicate the processed packets to the switching fabric for transmission over a core packet network.

Similarly, in another embodiment, the service edge node includes the first line card and the second line card each coupled to a common set of service cards.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a multi-service access network including a service edge node having a line card associated with numerous service cards according to one embodiment of the present invention;

FIG. 2 illustrates a multi-service access network including a service edge node having line cards each associated with a set of service cards according to another embodiment of the present invention;

FIG. 3 is a more detailed illustration of the line cards of FIGS. 1 and 2 according to one embodiment of the present invention;

FIG. 4 is a more detailed illustration of the service cards of FIGS. 1 and 2 according to one embodiment of the present invention;

FIG. 5 is a more detailed illustration of the control system of FIGS. 1 and 2 according to one embodiment of the present invention;

FIG. 6 illustrates a multi-service access network including a service edge node and more particularly provides a more detailed block diagram of the control system of the service edge node according to one embodiment of the present invention; and

FIG. 7 is a more detailed illustration of an exemplary embodiment of the subsystems of the control system of FIG. 6 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure.

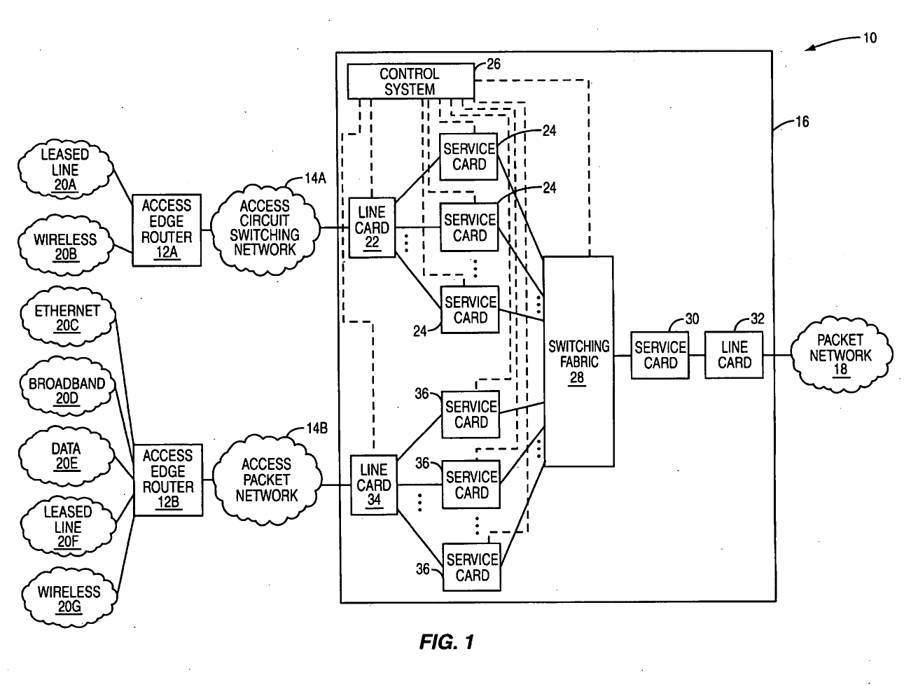

FIG. 1 illustrates a multi-service access network 10 according to one embodiment of the present invention. As illustrated, the multi-service access network 10 includes access edge nodes 12A and 12B, an access circuit-switching network 14A, an access packet network 14B, a service edge node 16, and a core packet network 18. As discussed below in detail, the focus of the present invention lies in the architecture of the service edge node 16. In general, the multi-service access network 10 provides an interface to numerous disparate networks 20A-20G. The networks 20A-20G are exemplary. Various types of networks that may be connected to the core packet network 18 via the multi-service access network 10 of the present invention will be apparent to one of ordinary skill in the art upon reading this disclosure.

The access edge nodes 12A, 12B, the access circuit-switching network 14A, and the access packet network 14B, respectively, form access networks for coupling the networks 20A-20G to the service edge node 16. As an example, the access circuit-switching network 14A may be a Generic Framing Protocol (GFP), a Virtual Concatenation (VCAT), or a Link Capacity Adjustment (LCAS) network, and the access packet network 14B may be an Ethernet network. In addition, the access packet network 14B may also include an Internet Protocol (IP), Multiprotocol Label Switching (MPLS), and/or Pseudo-Wire (PW) overlay.

According to one embodiment of the present invention, the service edge node 16 includes one or more line cards each associated with numerous service cards. More particularly, a first line card 22 is associated with N service cards 24. The first line card 22 may be coupled to the service cards 24 via a high-speed backplane such as a 2.5 Gigabit, 10 Gigabit, or 20 Gigabit backplane. It should be noted that other types of physical interconnects between the first line card 22 and the service cards 24 will be apparent to one of ordinary skill in the art upon reading this disclosure. In operation, the first line card 22 receives packets from the access circuit-switching network 14A, removes frame information from the packets, and passes raw packets including only a data portion of the packets to the service cards 24. As an example, the packets may be IP packets, packets associated with a frame relay connection, or packets associated with an Asynchronous Transfer Mode (ATM) or MPLS connection. In an exemplary embodiment, the packets received by the first line card 22 may be received at optical carrier (OC) levels such as OC48 and OC192 and/or may be transmitted to the first line card 22 as 1 Gigabit-Ethernet (GE) packets or 10 GE packets.

After the frame information is removed from the packets, each of the raw packets is directed to a particular one of the service cards 24. In one embodiment, the first line card 22 is configured to direct raw packets to the service cards 24 based on logical channels such as, but not limited to, VLAN and STS channels. Thus, all packets associated with a particular logical channel are directed to the service card 24 dedicated to that logical channel. In another embodiment, the raw packets are directed to the service cards 24 based on traffic types such as, but not limited to, public IP, private IP, Layer 2 VPN, and Layer 3 VPN. For this embodiment, the first line card 22 examines the packet to access packet information identifying the traffic type of the packet. Then, based on the packet information identifying the traffic type of the packet and a pre-configured table provided by a control system 26 which defines the traffic type handled by each of the service cards, the first line card 22 determines the service card 24 to which to direct the raw packet.

The service cards 24 process the raw packets from the first line card 22 based on routing information from the control system 26. Alternatively, the routing information may be cached locally on the service cards 24. In one embodiment, the service cards 24 perform Layer 2 and/or Layer 3 processing in preparation for transmission of the raw packets over the core packet network 18. Packet processing at the service cards 24 may include classification, filtering, conditioning, forwarding, queuing, scheduling, policing, remapping, and encapsulation. The processed packets are communicated to the core packet network 18 via switching fabric 28, which is also controlled by the control system 26, service card 30, and line card 32.

The service card 30 and line card 32 operate to logically and physically connect the switching fabric 28 to the core packet network 18. For example, the service card 30 and line card 32 operate as an interface to the core packet network 18 and may operate to communicate with the core packet network 18 at optical carrier levels such as OC-48 and OC-192. Functionally, the service card 30 operates similarly to the service cards 24. More specifically, because the output packets from the service cards 24 are each to be directed though the single line card 32, the service card 30 operates to provide such functions as queuing, traffic management, encapsulation, and mapping. The line card 32 operates similarly to the first line card 22 and provides a physical interface to the core packet network 18. Note, however, that the service card 30 and the line card 32 have greater capacity than the line card 22 and service cards 24.

Like the first line card 22, a second line card 34 is associated with M service cards 36. The numbers N and M of service cards 24 and 36, respectively, depend on the particular implementation and may or may not be the same. In one embodiment, the second line card 34 is coupled to the service cards 36 via a high-speed backplane such as a 2.5 Gigabit, 10 Gigabit, or 20 Gigabit backplane. It should be noted that other types of physical interconnects between the second line card 34 and the service cards 36 will be apparent to one of ordinary skill in the art upon reading this disclosure. In operation, the second line card 34 receives packets from the access packet network 14B, removes frame information from the packets, and passes raw packets including only a data portion of the packets to the service cards 36. As an example, the packets may be IP packets, packets associated with a frame relay connection, or packets associated with an ATM connection. In an exemplary embodiment, the packets received by the second line card 34 may be at optical carrier (OC) levels such as OC48 and OC192 and/or may be transmitted to the second line card 34 as 1 Gigabit-Ethernet (GE) packets or 10 GE packets.

After the frame information is removed from the packets, each of the raw packets is directed to a particular one of the service cards 36. In one embodiment, the second line card 34 is configured to direct raw packets to the service cards 36 based on logical channels such as, but not limited to, VLAN and STS channels. Thus, all packets associated with a particular logical channel are directed to the service card 36 dedicated to that logical channel. In another embodiment, the raw packets are directed to the service cards 36 based on traffic types such as, but not limited to, public IP, private IP, Layer 2 VPN, and Layer 3 VPN. For this embodiment, the second line card 34 examines the packet to access packet information identifying the traffic type of the packet. Then, based on the packet information identifying the traffic type of the packet and a pre-configured table provided by the control system 26 which defines the traffic type handled by each of the service cards, the second line card 34 determines the service card 36 to which to direct the raw packet.

The service cards 36 process the raw packets from the second line card 34 based on routing information from the control system 26. In one embodiment, the service cards 36 perform Layer 2 and/or Layer 3 processing in preparation for transmission of the raw packets over the core packet network 18. The processed packets are communicated to the core packet network 18 via the switching fabric 28, which is controlled by the control system 26, the service card 30, and the line card 32.

In one embodiment, the core packet network 18 is an Internet Protocol (IP)/Multiprotocol Label Switching (MPLS) network. Further, as an example, the processed packets may be transmitted from the service edge node 16 to the core packet network 18 as OC48 packets, OC1 92 packets, 1 GE packets, or 10 GE packets.

It should be noted that the embodiment of FIG. 1 illustrates both the access circuit switching network 14A and the access packet network 14B. As such, the service edge node 16 includes the first and second line cards 22 and 34, respectively. However, the multi-service access network 10 may include the access circuit switching network 14A but not the access packet network 14B. As such, the service edge node 16 would need only the first line card 22, service cards 24, control system 26, and switching fabric 28, and not the second line card 34 and the service cards 36. In yet another embodiment, the multi-service access network 10 includes the access packet network 14B but not the access circuit switching network 14A. As such, the service edge node 16 would need only the second line card 34, service cards 36, switching fabric 28, and control system 26, and not the first line card 22 and the service cards 24.

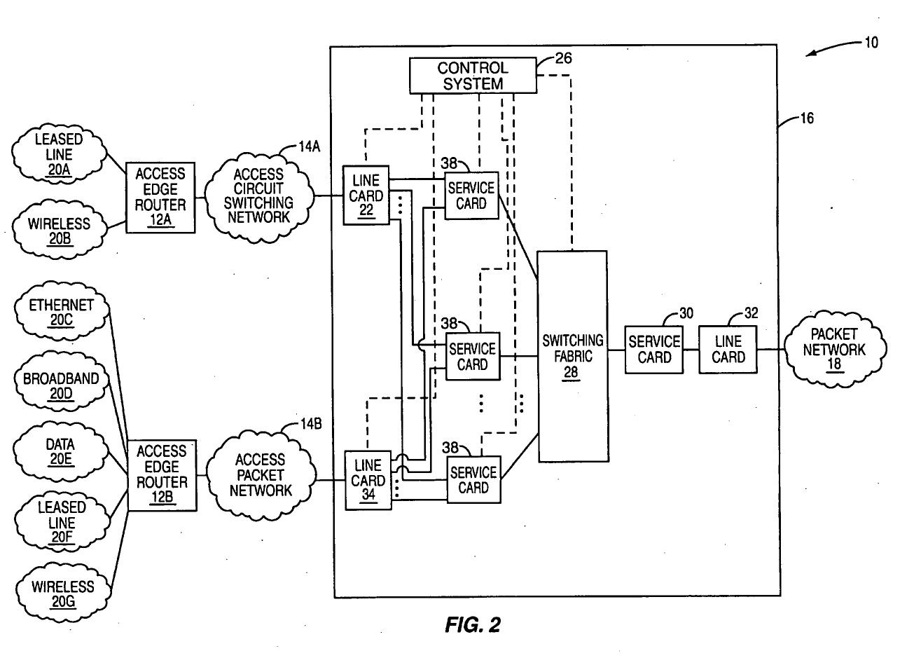

FIG. 2 illustrates another embodiment of the service edge node 16 of the present invention. This embodiment is similar to that of FIG. 1. However, the first line cards 22 and the second line cards 34 share a single set of service cards 38. More particularly, the first line card 22 and the second line card 34 are each associated with the service cards 38. The number of service cards 38 depends on the particular implementation. In one embodiment, the first and second-line cards 22, 34 are coupled to the service cards 38 via a high-speed backplane such as a 2.5 Gigabit, 10 Gigabit, or 20 Gigabit backplane. It should be noted that other types of physical interconnects between the line cards 22, 34 and the service cards 38 will be apparent to one of ordinary skill in the art upon reading this disclosure.

As discussed above, the first and second line cards 22, 34 operate to remove frame information from received packets and direct the raw packets to the service cards 38 based on logical channels or traffic types. For example, in one embodiment, each of the service cards 38 corresponds to a particular channel, such as a particular STS or VLAN channel. Accordingly, each of the first and second line cards 22, 34 operates to direct each of the raw packets to one of the service cards 38 dedicated to the particular channel of the raw packet. In another embodiment, each of the service cards 38 is dedicated for a particular traffic type. For example, there may be four service cards 38 with a first of the service cards 38 dedicated to public IP traffic, a second of the service cards 38 dedicated to private IP traffic, a third of the service cards 38 dedicated to Layer 2 VPN traffic, and a fourth of the service cards 38 dedicated to Layer 3 VPN traffic. Accordingly, the first and second line cards 22, 34 operate to direct the raw packets to the service cards 38 based on the traffic type of the packet. After processing by one of the service cards 38, each of the processed packets is transmitted to the core packet network 18 through the switching fabric 28, service card 30, and line card 32.

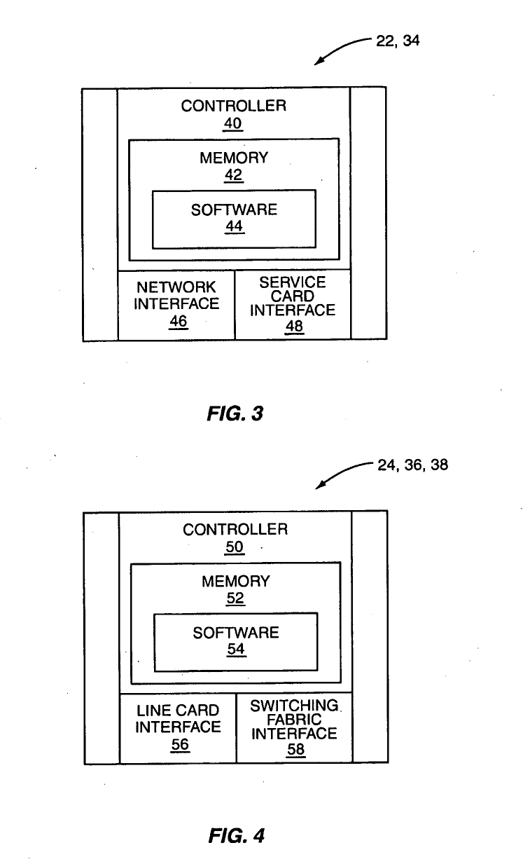

FIG. 3 illustrates an exemplary embodiment of the first and second line cards 22 and 34. For this discussion, the line card illustrated in FIG. 3 will be referred to as the line card 22. However, this discussion equally applies to each of the first and second line cards 22 and 34. In general, the line card 22 includes a controller 40 associated with memory 42 containing software 44. The line card 22 also includes a network interface 46 enabling communication with the circuit switching access network 14A and a service card interface 48 enabling communication with the service cards 24 or 38. In operation, the controller 40 operates to run the software 44, wherein the software 44 provides the functionality of the line card 22 described herein.

FIG. 4 illustrates an exemplary embodiment of the service cards 24, 36, and 38. For this discussion, the service card illustrated in FIG. 4 will be referred to as the service card 24. However, this discussion equally applies to each of the service cards 24, 36, and 38. In general, the service card 24 includes a controller 50 associated with memory 52 containing software 54. The service card 24 also includes a line card interface 56 enabling communication with the line card 22 and/or 34 and a switching fabric interface 58 enabling communication with the switching fabric 28. In operation, the controller 50 operates to run the software 54, wherein the software 54 provides the functionality of the service card 24 described herein.

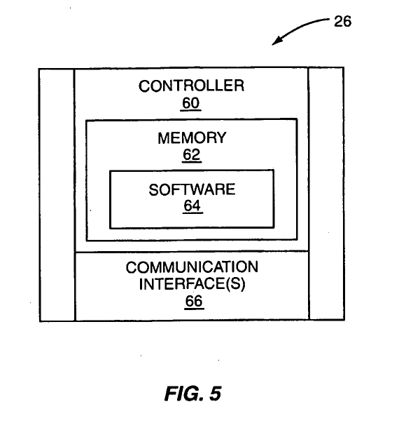

FIG. 5 illustrates an exemplary embodiment of the control system 26 of FIGS. 1 and 2. In general, the control system 26 includes a controller 60 associated with memory 62 containing software 64. The control system 26 also includes one or more communications interfaces 66 enabling communication with the line cards 22, 34; the service cards 24, 36, 38; and the switching fabric 28. In operation, the controller 60 operates to run the software 64, wherein the software 64 provides the functionality of the control system 26 described herein.

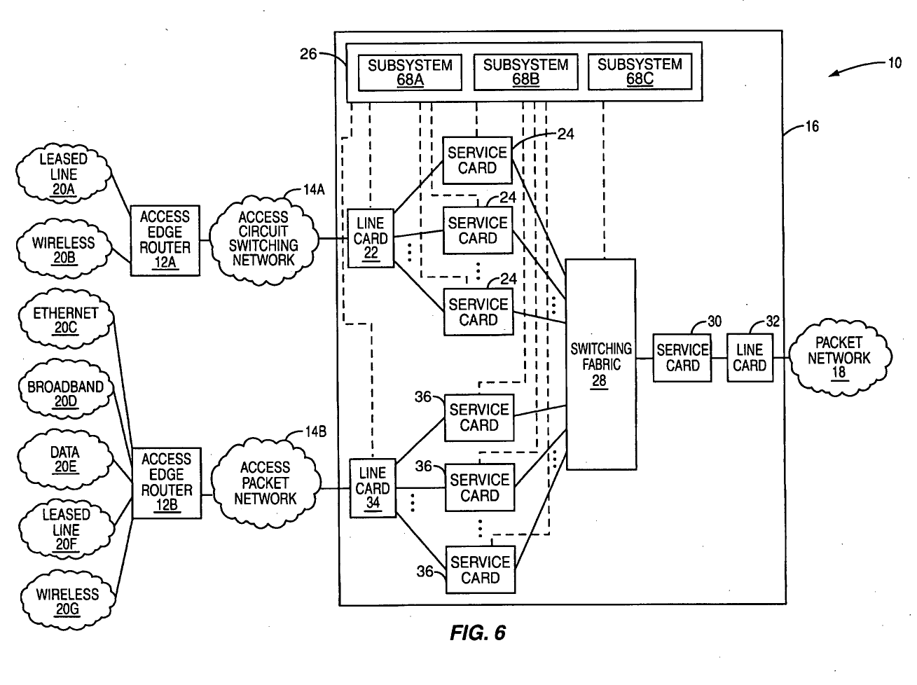

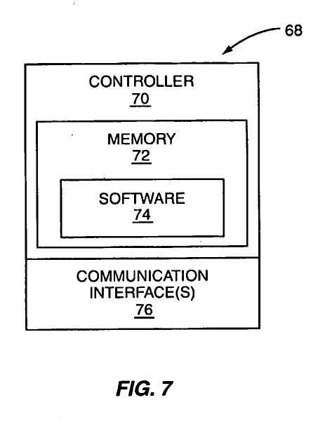

FIG. 6 illustrates the MSA network 10 of FIG. 1 including another exemplary embodiment of the control system 26. It should be noted that the following discussion of the control system 26 equally applies to the embodiment of FIG. 2. As illustrated, the control system 26 may include numerous subsystems 68A-68C, generally referred to as subsystem 68. As illustrated in FIG. 7, each of the subsystems 68 includes a controller 70 associated with memory 72 containing software 74. The software 74 may provide routing, signaling, or Layer 2 control functions. Each of the subsystems 68 also includes one or more communication interfaces 76 enabling communication with the first and second line cards 22, 34; the service cards 24, 36; and the switching fabric 28. Referring back to FIG. 6, each of the subsystems 68 is assigned to perform a specific application function and is associated with one or more of the service cards 24, 36. For example, one of the subsystems 68 runs the software 74, wherein the software 74 controls the controller 70 such that the subsystem 68 performs control functions for public IP traffic and, as such, is configured to be associated with ones of the service cards 24, 36 that are dedicated to public IP traffic. Further, in operation, the one of the subsystems 68 performing control functions for public IP traffic operates to handle a routing protocol of the public IP traffic such as the Open Shortest Path First (OSPF) routing protocol, perform routing computations to derive a forwarding table, and communicate the forwarding table to the ones of the associated ones of the service cards 24, 36. In a similar fashion, one of the subsystems 68 may be associated with ones of the service cards 24, 36 dedicated to private IP traffic, one of the subsystems 68 may be associated with ones of the service cards 24, 36 dedicated to Layer 2 VPN, and one of the subsystems 68 may be associated with ones of the service cards 24, 36 dedicated to Layer 3 VPN.

The service edge node 16 of the present invention provides substantial opportunity for variation without departing from the scope of the present invention. For example, in one embodiment, the first and second line cards 22, 34 direct packets to the service cards 24, 36, or 38 based on traffic type. As described above, in this embodiment, one of the service cards 24, 36, or 38 may be dedicated to public IP traffic. However, it should be noted that there may be numerous service cards 24, 36, or 38 dedicated to public IP traffic with each the service cards dedicated to public IP being more specifically dedicated to a specific range of public IP addresses.

Those skilled in the art will recognize improvements and modifications to the preferred embodiments of the present invention. All such improvements and modifications are considered within the scope of the concepts disclosed herein.

What is claimed is:

1. A service edge node for a multi-service access (MSA) network, comprising:
a) a plurality of service cards; and
b) a first line card adapted to:
i) receive packets from an access network;
ii) remove framing information from the packets to provide raw packets; and
iii) direct each of the raw packets to one of the plurality of service cards.

2. The service edge node of claim 1 wherein each of the plurality of service cards is dedicated to one of a plurality of logical channels and the first line card is further adapted to direct each of the raw packets to the one of the plurality of service cards dedicated to a one of the plurality of logical channels associated with the raw packet.

3. The service edge node of claim 2 further comprising switching fabric coupling each of the plurality of service cards to a core network wherein each of the plurality of service cards is further adapted to process the raw packets and provide processed packets to the core network via the switching fabric.

4. The service edge node of claim 3 wherein each of the plurality of service cards is further adapted to perform Layer 2 or Layer 3 processing to provide the processed packets.

5. The service edge node of claim 1 wherein each of the plurality of service cards is dedicated to one of a plurality of traffic types and the first line card is further adapted to direct each of the raw packets to the one of the plurality of service cards dedicated to a one of the plurality of traffic types associated with the raw packet.

6. The service edge node of claim 5 further comprising switching fabric coupling each of the plurality of service cards to a core network wherein each of the plurality of service cards is further adapted to process the raw packets and provide processed packets to the core network via the switching fabric.

7. The service edge node of claim 5 wherein the first line card is further adapted to examine the packets to determine the one of the plurality of traffic types associated with the raw packet and to direct each of the raw packets to the one of the plurality of service cards dedicated to the one of the plurality of traffic types associated with the raw packet based on a pre-configured table associating the plurality of service cards and the plurality of traffic types.

8. The service edge node of claim 1 further comprising a control system having a plurality of subsystems each associated with one of the plurality of service cards.

9. The service edge node of claim 1 further comprising a second line card adapted to:
receive packets from a second access network;
remove framing information from the packets from the second access network to provide raw packets from the second access network; and
direct each of the raw packets from the second line card to a one of the plurality of service cards.

10. The service edge node of claim 9 wherein each of the plurality of service cards is dedicated to one of a plurality of logical channels, the first line card is further adapted to direct each of the raw packets from the first line card to the one of the plurality of service cards dedicated to a one of the plurality of logical channels associated with the raw packet, and the second line card is further adapted to direct each of the raw packets from the second line card to the one of the plurality of service cards dedicated to a one of the plurality of logical channels associated with the raw packet from the second line card.

11. The service edge node of claim 9 wherein each of the plurality of service cards is dedicated to one of a plurality of traffic types, the first line card is further adapted to direct each of the raw packets from the first line card to the one of the plurality of service cards dedicated to a one of the plurality of traffic types associated with the raw packet from the first line card, and the second line card is further adapted to direct each of the raw packets from the second line card to the one of the plurality of service cards dedicated to a one of the plurality of traffic types associated with the raw packet from the second line card.

12. A method of connecting one or more access networks to a core network comprising:
receiving packets from an access network at a first line card;
removing framing information from the packets to provide raw packets; and
directing each of the raw packets from the first line card to one of a plurality of service cards.

13. The method of claim 12 wherein each of the plurality of service cards is dedicated to one of a plurality of logical channels and directing each of the raw packets comprises directing each of the raw packets from the first line card to a one of the plurality of service cards dedicated to a one of the plurality of logical channels associated with the raw packet.

14. The method of claim 13 further comprising processing the raw packets at the plurality of service cards to provide processed packets and providing the processed packets to the core network via switching fabric coupling each of the plurality of service cards to the core network.

15. The method of claim 12 wherein each of the plurality of service cards is dedicated to one of a plurality of traffic types and directing each of the raw packets comprises directing each of the raw packets from the first line card to a one of the plurality of service cards dedicated to a one of the plurality of traffic types associated with the raw packet.

16. The method of claim 15 further comprising processing the raw packets at the plurality of service cards to provide processed packets and providing the processed packets to the core network via switching fabric coupling each of the plurality of service cards to the core network.

17. The method of claim 15 further comprising examining the packets at the first line card to determine the one of the plurality of traffic types associated with the raw packet and wherein directing each of the raw packets comprises directing each of the raw packets from the first line card to a one of the plurality of service cards dedicated to the one of the plurality of traffic types associated with the raw packet based on a pre-configured table associating the plurality of service cards and the plurality of traffic types.

18. The method of claim 12 further comprising:
receiving packets from a second access network at a second line card;
removing framing information from the packets from the second access network to provide raw packets from the second line card; and
directing each of the raw packets from the second line card to a one of the plurality of service cards.

19. The method of claim 18 wherein each of the plurality of service cards is dedicated to one of a plurality of logical channels and:
directing each of the raw packets from the first line card comprises directing each of the raw packets from the first line card to the one of the plurality of service cards dedicated to a one of the plurality of logical channels associated with the raw packet; and
directing each of the raw packets from the second line card comprises directing each of the raw packets from the second line card to the one of the plurality of service cards dedicated to a one of the plurality of logical channels associated with the raw packet from the second access network.

20. The method of claim 18 wherein each of the plurality of service cards is dedicated to one of a plurality of traffic types and:
directing each of the raw packets from the first line card comprises directing each of the raw packets from the first line card to the one of the plurality of service cards dedicated to a one of the plurality of traffic types associated with the raw packet from the first access network; and
directing each of the raw packets from the second line card comprises directing each of the raw packets from the second line card to the one of the plurality of service cards dedicated to a one of the plurality of traffic types associated with the raw packet from the second access network.
